(19) United States
(12) Patent Application Publication
(10) Pub. No.: US 2025/0236731 A1
(43) Pub. Date: Jul. 24, 2025

(54) HIGH-EFFICACY FLAME RETARDANT FORMULATIONS FOR POLYAMIDE AND THE METHOD OF PRODUCING THEM

(71) Applicant: Agency for Science, Technology and Research, Singapore (SG)

(72) Inventors: Jun Hua Kong, Singapore (SG); Songlin Liu, Singapore (SG); Qi Feng Lim, Singapore (SG); Chin Chong Yap, Singapore (SG); Warintorn Thitsartarn, Singapore (SG); Maureen Janet Beng Hoon Tan, Singapore (SG); Chaobin He, Singapore (SG)

(21) Appl. No.: 18/698,739

(22) PCT Filed: Oct. 7, 2022
(86) PCT No.: PCT/SG2022/050718

§ 371 Date: Apr. 4, 2024

(30) Foreign Application Priority Data
Oct. 7, 2021 (SG) 10202111181P

(51) Int. Cl. C08L 77/02; C08J 3/20; C08K 3/38; C08K 5/053; C08K 5/3492; C08K 5/52; C08K 5/5313

(52) U.S. Cl. CPC C08L 77/02; C08J 3/203; C08K 3/38; C08K 5/053; C08K 5/34922; C08K 5/34924; C08K 5/5205; C08K 5/5313; C08J 2377/02; C08J 2485/02; C08K 2003/387; C08K 2201/014; C08L 2201/02

(57) ABSTRACT

A flame retardant polyamide composite that includes a polyamide and a synergist, where the synergist includes a polymer having a backbone and a side unit of 9,10-dihydro-9-oxa-10-phosphaphenanthrene 10-oxide bonded thereto. Furthermore, the backbone of the polymer includes at least one heterocyclic moiety. Additionally, the flame retardant polyamide composite includes a flame retardant agent, where the synergist and the flame retardant agent are present in an amount ranging from more than 0 to 10 wt %. Furthermore, a method of forming the flame retardant polyamide composite includes cryogenic milling a synergist, mixing the synergist with a flame retardant agent to obtain a mixture, and compounding the mixture with a polyamide to obtain the flame retardant polyamide composite.

### CROSS-REFERENCE TO RELATED APPLICATION

This application claims the benefit of priority of Singapore patent application Ser. No. 10/202,111181P, filed 7 Oct. 2021, the content of it being hereby incorporated by reference in its entirety for all purposes.

### TECHNICAL FIELD

The present disclosure relates to a flame retardant polyamide composite. The present disclosure also relates to a method of forming the flame retardant polyamide composite.

### BACKGROUND

Polyamides (PAs) and their reinforced grades may have found wide uses in most industries, as they appear to be one of the popular synthetic engineering thermoplastics, due to their good mechanical properties, excellent wear and chemical resistance, and ease of processability.

That said, polyamide products may often need to be flame retardant (FR) due to sustainability requirements in most of the end-use environment and to satisfy safety considerations. Several approaches may have been explored to improve the flame retardant properties of polyamides. These approaches may differ in terms of the underlying mechanism in which the flame retardancy of polyamide-based materials gets improved, as each of these approaches may involve different additives. The additive may be an additive based on one or more halogens, phosphorus, a mineral, nitrogen, silicon, boron, or even a combination thereof.

However, such additives may have their limitations. For example, additive based on one or more halogens tend to be gradually prohibited from use due to the toxicity and environmental harm from a halogen. For this reason, flame retardant products absent of halogen became of interest, especially those derived using polyamide. Various halogen-free flame retardant additives (one example includes ammonium salts) were then commercially developed.

Despite the rich diversity of halogen-free flame retardant additives traditionally available for polyamides, it should be noted that such traditional products tend to require an undesirably high loading of the flame retardant additive in a polyamide matrix in order to achieve a minimal or satisfying flame retardancy performance, i.e. UL94 VO rating (which is a plastic flammability standard used at least in the United States of America). For example, it was recommended on a technical datasheet of one commercially available flame retardant additive that a dosage of 15 wt % to 20 wt % of a glass fibre reinforced polyamide be used. In a further example, it was recommended on a technical datasheet of another commercially available flame retardant additive that a dosage of 25 wt % of a glass fibre reinforced polyamide be used. Such high loading of the flame retardant additive may render the polyamide susceptible to certain disadvantages. The disadvantages may include lowered economical value due to increased cost from the higher loading of flame retardant additive, and/or the compromise of other properties (e.g. mechanical properties) of the resultant polyamide.

There is thus a need to provide for a solution that addresses one or more of the limitations mentioned above. The solution should at least provide for a polyamide that is flame retardant and yet without having the polyamide's properties compromised.

### SUMMARY

In a first aspect, there is provided for a flame retardant polyamide composite comprising:
a polyamide;
a synergist,
wherein the synergist comprises a polymer having a backbone and a side unit of 9,10-dihydro-9-oxa-10-phosphaphenanthrene 10-oxide bonded thereto, wherein the backbone of the polymer comprises at least one heterocyclic moiety; and
a flame retardant agent,
wherein the synergist and the flame retardant agent are present in an amount ranging from more than 0 to 10 wt %.

In another aspect, there is provided for a method of forming the flame retardant polyamide composite described in various embodiments of the first aspect, the method comprising:
cryogenic milling a synergist;
mixing the synergist with a flame retardant agent to obtain a mixture; and
compounding the mixture with a polyamide to obtain the flame retardant polyamide composite.

### BRIEF DESCRIPTION OF THE DRAWINGS

The drawings are not necessarily to scale, emphasis instead generally being placed upon illustrating the principles of the present disclosure. In the following description, various embodiments of the present disclosure are described with reference to the following drawings, in which:

FIG. 1A shows a table for the flame retardant property of the flame retardant polyamide composites demonstrated in examples 2A to 2D. “d” denotes for dripping and “eud” denotes for extinguish upon dripping. The sample formed using PA6/Exolit® OP 1314, which is deemed a control sample, is denoted “benchmark”.

FIG. 1B shows a table (top image) for the flame retardant property of the flame retardant polyamide composites demonstrated in examples 2E to 2G. “d” denotes for dripping and “eud” denotes for extinguish upon dripping. The bottom table (bottom image) compares the mechanical properties of control against composites of example 2B and 2F. The sample formed using PA6/Exolit® OP 1314, which is deemed a control sample, is denoted “benchmark”.

FIG. 1C are screenshots of the UL94 tests of the various composites (neat PA6, comparative and control composites demonstrated in examples 3A to 3C, and composites demonstrates in examples 2A to 2G) that are able to achieve UL94 VO rating. The sample formed using PA6/Exolit® OP 1314, which is deemed a control sample, is denoted “benchmark”.

FIG. 2A shows the mechanical properties (tensile modulus, maximum tensile strength, Izod impact toughness) of the flame retardant polyamide composites using ADP as the flame retardant agent (examples 2A to 2D) and the comparative sample (example 3A) and the control sample (based on PA6/Exolit® OP 1314). Five specimens were measured for each type of composite.

FIG. 2B shows a comparison of the mechanical properties (tensile modulus, maximum tensile strength, Izod impact toughness) of the presently developed flame retardant composites using ADP as the flame retardant, the comparative sample (example 3A) and the control sample (based on PA6/Exolit® OP 1314) that achieve UL94 VO rate at the lowest flame retardant agent loading. Five specimens were measured for each type of composite.

FIG. 3A shows the mechanical properties (tensile modulus, maximum tensile strength, Izod impact toughness) of the flame retardant polyamide composites using MCA as the flame retardant agent (examples 2E to 2G) and the comparative sample (example 3B) and the control sample (based on PA6/Exolit® OP 1314). Five specimens were measured for each type of composite.

FIG. 3B shows a comparison of the mechanical properties (tensile modulus, maximum tensile strength, Izod impact toughness) of the presently developed flame retardant composites using MCA as the flame retardant, the comparative sample (example 3B) and the control sample (based on PA6/Exolit® OP 1314) that achieve UL94 VO rate at the lowest flame retardant agent loading. Five specimens were measured for each type of composite.

FIG. 4 shows a chemical structure of DOPO-PhOH-SPDPC, which is referred to as “DPS” in the present disclosure for brevity, wherein “n” can range from 2 to about 1000, for example, 2 to about 450.

FIG. 5 shows the chemical structure of aluminum diethyl phosphinate (ADP) (left image), melamine phosphate (MPP) (center image), and melamine cyanurate (MCA) (right image). “n” can range from 1 to about 100.

### DETAILED DESCRIPTION

The following detailed description refers to the accompanying drawings that show, by way of illustration, specific details and embodiments in which the present disclosure may be practised.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The present disclosure relates to a flame retardant polyamide composite and a method of forming the flame retardant polyamide composite. Advantageously, the present flame retardant polyamide composite has significantly better flame retardancy as compared to polyamides incorporated with traditional flame retardant agent, even when the present flame retardant polyamide composite has a relatively lower amount of the flame retardant agent. Also, even when a relatively lower amount of flame retardant agent is incorporated, the present flame retardant polyamide composite is able to meet a UL94 VO flame retardancy rating.

In certain instances, the addition of a traditional flame retardant agent in a polyamide may compromise the properties (e.g. mechanical properties) of the polyamide. Conversely, the properties of polyamide in the present flame retardant polyamide composite, such as the polyamide's mechanical properties, are not compromised by the incorporation of the present flame retardant agent. 15

In other instances, a traditional flame retardant agent may be toxic and harmful to the environment, which in turn renders a polyamide incorporated with such flame retardant agent less desirable and even avoided for use. The present flame retardant polyamide composite circumvents the use of such traditional flame retardant agent.

Details of various embodiments of the present flame retardant polyamide composite and its method of forming, and advantages associated with the various embodiments are now described below. Where the embodiments and advantages are described in the examples section further hereinbelow, they shall not be iterated for brevity.

In the present disclosure, there is provided a flame retardant polyamide composite. The flame retardant polyamide composite comprises polyamide, a synergist, and a flame retardant agent.

In various embodiments, the synergist may comprise or consist of a polymer having a backbone and a side unit of 9,10-dihydro-9-oxa-10-phosphaphenanthrene 10-oxide bonded thereto. In various embodiments, the backbone of the polymer may comprise at least one heterocyclic moiety. The heterocyclic moiety can contain one or more heteroatoms, wherein the heteroatom comprises or consists of an oxygen and/or nitrogen. The synergist synergizes and maximizes the flame retardant mechanisms from the mixed components. The synergized flame retardant mechanisms advantageously provide better flame retardant performance to the polymer.

In various embodiments, the synergist and the flame retardant agent may be present in an amount ranging from more than 0 to 10 weight percent (wt %), 6 to 10 wt %, 8 to 10 wt %, etc.

In various embodiments, the polyamide may comprise a nylon, polyamide 6, polyamide 6,6, polyamide 4,6, polyamide 6,10, polyamide 11, or polyamide 12. The polyamide serves as the polymer matrix in which the synergist and the flame retardant agent are incorporated.

In various embodiments, the synergist may comprise a polymer having a repeating unit represented by a chemical structure as shown below:

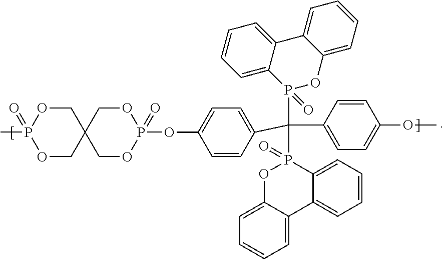

In certain non-limiting embodiments, the synergist may comprise or consist of DPS.

In various embodiments, the flame retardant agent may comprise a phosphinate, a phosphate, a melamine, or a derivative thereof. Such flame retardant agents can provide char formation (i.e. carbonization capability) in condensed solid phase as well as radical scavenging and/or inert gas releasing capability in gaseous phase, all of which serve as flame retardant mechanisms to extinguish flames. In various embodiments, the flame retardant agent may comprise aluminum diethyl phosphinate, melamine phosphate, and/or melamine cyanurate. Such flame retardant agents provide char formation (i.e. carbonization capability) in condensed solid phase as well as radical scavenging and/or inert gas releasing capability in gaseous phase, all of which serve as flame retardant mechanisms to extinguish flames. For example, aluminum diethyl phosphinate can be a char source for char formation (i.e. carbonization capability) in condensed solid phase as well as provide radical scavenging and inert gas releasing capability in gaseous phase.

In various embodiments, the synergist and the flame retardant agent may be present in a weight ratio ranging from 1:2.4 to 1:4, 1:2.4 to 1:3, 1:3 to 1:4, 1:4, etc.

In certain non-limiting embodiments, the flame retardant polyamide composite may further comprise a char forming agent. The char forming agent forms a protective char layer either through self-char formation or carbonizing the polymer (e.g. carbonizing at least a part of the polymer) during the buring of the composite, which helps stop any further burning. The char forming agent may comprise a carbon source or a mineral material. The mineral material herein refers to natural or synthetic oxides, sulphides, hydroxides, carbonates, borates, stannates of silicon, aluminium, magnesium, and zinc. The char forming agent may comprise pentaerythritol or zinc borate. Advantageously, pentaerythritol can be easily carbonized into carbon phase with high carbon yield, and zinc borate is able to (1) promote char formation through additional formation of ZnO upon degradation, (2) release water to cool the flame and the composite hence reducing and/or eliminating energy to the fire, (3) easily synergize with other flame retardant additives, and (4) suppress smoke.

In certain non-limiting embodiments, the flame retardant polyamide composite may further comprise a blowing agent. The blowing agent releases inert gas to (1) expand the formed char phase for a better protection and (2) dilute any surrounding oxygen concentration to suppress any burning. The blowing agent may comprise melamine or a derivative thereof. Melamine and its derivatives may have high nitrogen content, which renders the release of a significant amount of nitrogen gas upon degradation, providing high blowing efficiency. Moreover, its degradation temperature is compatibly suitable for use with most of the char forming agent.

The present disclosure also provides for a method of forming the flame retardant polyamide composite described in various embodiments of the first aspect. Embodiments and advantages described for the present flame retardant polyamide composite of the first aspect can be analogously valid for the present method subsequently described herein, and vice versa. Where the various embodiments and advantages have already been described above and demonstrated in the examples demonstrated further herein, they shall not be iterated for brevity.

The method may comprise cryogenic milling a synergist, mixing the synergist with a flame retardant agent to obtain a mixture, and compounding the mixture with a polyamide to obtain the flame retardant polyamide composite. The terms “cryogenic milling” and “cryo-crushing” are used exchangeably in the present disclosure. The mixing of the synergist and the flame retardant agent is carried out prior to the compounding step. In various non-limiting embodiments, the mixing step can be carried out prior out to the compounding step. Advantageously, a homogeneous mixture helps in avoiding any severe phase separation of the various components in the resultant composite.

The cryogenic milling of the present method is a variation of mechanical milling, in which powders or samples are milled (i.e. grinded) in the presence of a cryogen. The cryogen may be liquid nitrogen. Any suitable apparatus operable to carry out cryogenic milling may be used.

In various embodiments, cryogenic milling the synergist may be carried out at a temperature in a range of −250° C. to −100° C., −200° C. to −100° C., −150° C. to −100° C., −250° C. to −200° C., −250° C. to −150° C., −200° C. to −150° C., etc.

In various embodiments, cryogenic milling the synergist may be carried out for at least 3 cycles (e.g. 3 to 10 cycles). In various embodiments, each cycle may be carried out at 10 to 15 Hz and for 1 to 3 minutes. In certain non-limiting examples, the cryogenic milling may be carried out for 5 cycles, each cycle about 2 minutes and at 13 Hz.

In various embodiments, mixing the synergist and the flame retardant agent may comprise ball milling the synergist and the flame retardant. In various embodiments, mixing (e.g. ball milling) the synergist and the flame retardant are carried out for 1 to 3 hours and at a speed of 200 to 300 rpm. In certain non-limiting examples, mixing the synergist and the flame retardant agent may be carried out for 2 hours and at a speed of 200 rpm.

In certain non-limiting embodiments, mixing the synergist and the flame retardant may further comprise mixing the synergist and the flame retardant in the presence of a char forming agent and/or a blowing agent to form the mixture.

In various embodiments, compounding the mixture with the polyamide may be carried out in an extruder. In certain non-limiting embodiments, the extruder may be a twin screw extruder. Other suitable extruders for compounding the mixture with the polyamide into pellets may be used.

In various embodiments, compounding the mixture with the polyamide may be carried out at a temperature of 220° C. to 260° C. and at a speed of 100 to 200 rpm. In certain non-limiting instances, the compounding can be carried out at a 240° C. and at a speed of 150 rpm.

In summary, the present flame retardant polyamide composite and method involve a reduced loading of the flame retardant filler loading, and yet is able to meet the flame retardancy rating of UL94 VO. The terms “flame retardant agent”, “flame retardant filler”, and “flame retardant additive”, are used exchangeably in the present disclosure. Advantageously, there is a balance on different aspects of the properties of the resultant composite and cost can be reduced for producing the present composite as compared to traditional flame retardant polyamides. The present method affords such advantage, which can be realized through a simple and straightforward high efficacy flame retardant formulations for the composites as described above.

The formulations and hence the developed polyamide composites of the present disclosure demonstrate significant improvement over the comparative and control samples (see examples 3A to 3C) in terms of flame retardancy and mechanical properties, e.g. lower loading required to achieve UL94 VO rating, and better mechanical properties under the premise of the VO rating.

Observably, the present polyamide composite and method offer enhanced flame retardant properties for the use of polyamides in various applications.

Where the word “substantially” is used, it does not exclude “completely” e.g. a composition which is “substantially free” from Y may be completely free from Y.

Where necessary, the word “substantially” may be omitted from the definition of the present disclosure.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

Unless specified otherwise, the terms “comprising” and “comprise”, and grammatical variants thereof, are intended to represent “open” or “inclusive” language such that they include recited elements but also permit inclusion of additional, unrecited elements.

### Examples

The present disclosure relates to a flame retardant polyamide composite and a method of forming the flame retardant polyamide composite. The flame retardant polyamide composite is composed from formulations that are configurable to produce polyamide composites (e.g. nylon composites) with significantly enhanced flame retardant (FR) properties without affecting properties (e.g. mechanical properties) of the polyamide.

The formulations, and hence the flame retardant polyamide composite, can include a synergist and/or a flame retardant agent. The formulations, and hence the flame retardant polyamide composite, can also include other components, such as a carbon source, a blowing agent, etc. The terms “flame retardant agent”, “flame retardant filler”, and “flame retardant additive” are used exchangeably in the present disclosure.

Advantageously, compared to pure nylon and nylon containing traditional flame retardant additive, the polyamide composites (e.g. nylon composites) of the present disclosure (produced using aforesaid formulations) possess significantly enhanced flame retardancy performance. That is to say, the flame retardant polyamide composites of the present disclosure not only meet the standard rating of UL94 VO, but is also able to do so with a relatively much lower loading of the flame retardant agent in the polyamide. For example, the flame retardant agent required for loading in the polyamide composite of the present disclosure is lower than those present in traditional polyamide products and also lower than what is required by traditional flame retardant agent. At the same time, mechanical properties of the present flame retardant polyamide composites (e.g. flame retardant nylon composites) are still better than polyamide composites incorporated with traditional flame retardant agent.

The present flame retardant polyamide composite and its method of forming are described in further details, by way of non-limiting examples, as set forth below.

### Example 1A: General Discussion on Present Flame Retardant Polyamide Composite and its Method of Forming

The present example describes formulations for polyamide composites of the present disclosure having superior flame retardancy using relatively low flame retardant agent and yet without compromising mechanical properties, as compared to control samples. The flame retardant polyamide composites of the present disclosure can include (i) a polyamide resin, and (ii) a flame retardant agent and/or a synergist. Optionally, a char forming agent and/or a blowing agent can be included. In various non-limiting examples, the formulations and hence the flame retardant polyamide composite of the present disclosure can include a flame retardant agent, a synergist, and/or a char forming agent, and/or a blowing agent.

The polyamide resin used can include an aliphatic polyamide, a semi-aromatic polyamide, and an aromatic polyamide. In the context of the present disclosure, the term “semi-aromatic polyamide” refers to one containing at least 55 mol % of terephthalic acid and/or isophthalic acid in the carboxylic acid portion of the repeating units (i.e. the entire polyamide). Non-limiting examples of the polyamide resin tested include a polyamide, such as a nylon, polyamide 6 (PA6), polyamide 6,6 (PA6,6), polyamide 4,6 (PA4,6), polyamide 6,10 (PA6,10), polyamide 11 (PA11), and polyamide 12 (PA12). These polyamides are non-limiting examples of aliphatic polyamides.

The synergist of the present disclosure can be a polymer having a backbone and a side unit of 9,10-dihydro-9-oxa-10-phosphaphenanthrene 10-oxide bonded thereto.

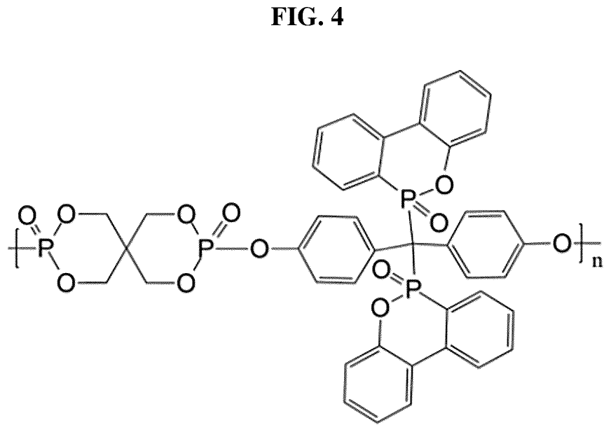

The backbone of the polymer can include at least one heterocyclic moiety. The heterocyclic moiety can contain one or more heteroatoms, wherein the heteroatom comprises or consists of an oxygen and/or nitrogen. In various non-limiting examples, the synergist can be a polymer chemically featuring SPDPC-containing long chain backbones with DOPO side segments (DOPO-PhOH-SPDPC, referred to as DPS). The chemical structure of DPS is shown in FIG. 4.

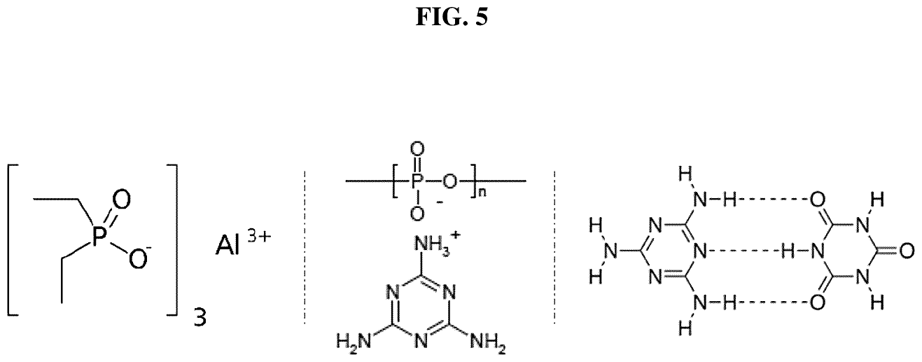

The flame retardant agent used in the present disclosure, can be a phosphinate, a phosphate, a melamine, or a derivative thereof. In various non-limiting examples, the flame retardant agent can be aluminium diethyl phosphinate (ADP), melamine phosphate (MPP), or melamine cyanurate (MCA) (see left, center and right images, respectively, in FIG. 5).

The char forming agent can be any suitable carbon source or a mineral material. Non-limiting examples of the char forming agent can include pentaerythritol (PER) and zinc borate (ZB).

The blowing agent can be a melamine or a melamine derivatives A non-limiting example used herein is melamine. Where needed or present, the blowing agent can serve as a flame retardant agent.

### Example 1B: General Discussion on Method of Forming the Present Flame Retardant Polyamide Composite

The present examples describe the method of producing the flame retardant polyamide composite. In general, the method can involve the following steps: (a) cryo-crushing of the synthesized synergist (e.g. DOPO-PhOH-SPDPC, referred to as DPS, see FIG. 4) to obtain fine powders thereof having a uniform size, (b) pre-mixing of one or more of the flame retardant agents with the synergist at a pre-calculated composition using ball milling to form a homogeneous mixture, (c) compounding of polyamide pellets and the mixture with certain loading using twin-screw extruder to form the flame retardant polyamide composite, and optionally (d) subjecting the flame retardant polyamide composite to injection moulding to further produce injection moulded coupons for flame retardancy and mechanical properties evaluation. The term “pre-mixing” herein refers to mixing of materials prior to another step. In this instance, the flame retardant agent and synergist are mixed prior to the compounding step. The “certain loading” refers to a dosage of the homogenous mixture used in the compounding. As described in the examples demonstrated below, the homogenous mixture loaded into the polymer for compounding may be about 6 wt % to about 15 wt % based on the resultant composite.

In various non-limiting examples, the method of forming the flame retardant polyamide composites of the present disclosure can include steps of cryo-crushing, pre-mixing, compounding, and/or injection moulding as mentioned above.

In various non-limiting examples, the cryo-crushing can be conducted using a suitable frequency and period, such as 10 to 15 Hz and 3 to 10 cycles with 1 to 3 mins for each cycle. Advantageously, any material or powder can be adequately milled into fine powder under these conditions. In certain non-limiting examples, the frequency used can be 13 Hz with 5 cycles and 2 mins for each cycle.

In various non-limiting examples, the pre-mixing can be carried out in a ball milling drum rotating at certain speed and period, for example, 200 to 300 rpm and for 1 to 3 hrs, respectively. Advantageously, the mixture can be well homogenized under such pre-mixing conditions. In certain non-limiting examples, the ball milling can be carried out at 200 rpm and for 2 hrs.

In various non-limiting examples, the compounding using a screw extruder (e.g. a twin screw extruder) can be carried out at a temperature of 220 to 260° C. and a rotation speed of 100 to 200 rpm. Advantageously, such conditions render efficient compounding of the mixture and the polyamide without damaging either components. In certain non-limiting examples, the compounding is carried out at 240 to 250° C. and 150 rpm.

In various non-limiting examples, the injection moulding can be carried out at a temperature and a pressure of 220 to 260° C. and 150 to 400 psi, respectively. Advantageously, such conditions render efficient moulding of the compounded composite pellets into testing specimen without degrading the composite. In certain non-limiting examples, the injection moulding is carried out at 240 to 250° C. and 200 20) to 250 psi, respectively.

### Example 2A: An Example of the Present Flame Retardant Polyamide Composite

PA6 (Ultramid® B3K, BASF) was used as the polymer matrix (i.e. the polyamide), and ADP (Sanwa Flame Retardant Technology Ltd, China) was used as the flame retardant agent. The DPS synergist (which was cryo-crushed) and ADP were pre-mixed at a weight ratio of 1 to 3, after which the mixture was compounded with PA6 pellets. The overall loading of (DPS+ADP) ranges from 6 wt % to 10 wt %, specifically being 6 wt %, 8 wt %, and 10 wt %, wherein the wt % is based on the resultant composite. The composite pellets were then injection moulded into coupons for mechanical and flame retardancy testing. 30)

### Example 2B: An Example of the Present Flame Retardant Polyamide Composite

PA6 (Ultramid B3K, BASF) was used as the polymer matrix (i.e. the polyamide), and ADP (Sanwa Flame Retardant Technology Ltd, China) was used as the flame retardant agent. The DPS synergist (which was cryo-crushed) and ADP was pre-mixed at a weight ratio of 1 to 4, after which the mixture was compounded with PA6 pellets. The overall loading of (DPS+ADP) ranges from 6 wt % to 10 wt %, being 6 wt %, 8 wt %, and 10 wt %. The composite pellets were then injection moulded into coupons for mechanical and flame retardancy testing.

### Example 2C: An Example of the Present Flame Retardant Polyamide Composite

PA6 (Ultramid B3K, BASF) was used as the polymer matrix (i.e. the polyamide), and ADP (Sanwa Flame Retardant Technology Ltd, China) was used as the flame retardant agent, and PER as the carbon source (i.e. char forming agent). The DPS synergist (which was cryo-crushed), PER and ADP were pre-mixed at a weight ratio of 1:0.6:2.4, after which the mixture was compounded with PA6 pellets. The overall loading of (DPS+PER+ADP) ranges from 6 wt % to 10 wt %, being 6 wt %, 8 wt %, and 10 wt %. The composite pellets were then injection moulded into coupons for mechanical and flame retardancy testing.

### Example 2D: An Example of the Present Flame Retardant Polyamide Composite

PA6 (Ultramid® B3K, BASF) was used as the polymer matrix (i.e. the polyamide), and ADP (Sanwa Flame Retardant Technology Ltd, China) was used as the flame retardant agent, and zinc borate (FiberbrakeR ZB, Borax). The DPS synergist (which was cryo-crushed), zinc borate (ZB) and ADP were pre-mixed at a weight ratio of 1 to 3 based on DPS to (ZB+ADP) and at a ZB loading of 1.5 wt % based on the resultant composite, after which the mixture was compounded with PA6 pellets. The overall loading of (DPS+ZB+ADP) ranges from 6 wt % to 10 wt %, being 6 wt %, 8 wt %, and 10 wt %. The composite pellets were then injection moulded into coupons for mechanical and flame retardancy testing.

### Example 2E: An Example of the Present Flame Retardant Polyamide Composite

PA6 (Ultramid® B3K, BASF) was used as the polymer matrix (i.e. the polyamide), and MCA (Sanwa Flame Retardant Technology Ltd, China) was used as the flame retardant agent. The DPS synergist (which was cryo-crushed) and MCA were pre-mixed at a weight ratio of 1 to 3, after which the mixture was compounded with PA6 pellets. The overall loading of (DPS+MCA) ranges from 6 wt % to 10 wt %, being 6 wt %, 8 wt %, and 10 wt %. The composite pellets were then injection moulded into coupons for mechanical and flame retardancy testing.

### Example 2F: An Example of the Present Flame Retardant Polyamide Composite

PA6 (Ultramid® B3K, BASF) was used as the polymer matrix (i.e. the polyamide), and MCA (Sanwa Flame Retardant Technology Ltd, China) was used as the flame retardant agent. The DPS synergist (which was cryo-crushed) and MCA were pre-mixed at a weight ratio of 1 to 4, after which the mixture was compounded with PA6 pellets. The overall loading of (DPS+MCA) ranges from 6 wt % to 10 wt %, being 6 wt %, 8 wt %, and 10 wt %. The composite pellets were then injection moulded into coupons for mechanical and flame retardancy testing.

### Example 2G: An Example of the Present Flame Retardant Polyamide Composite

PA6 (Ultramid B3K, BASF) was used as the polymer matrix (i.e. the polyamide), and MCA (Sanwa Flame Retardant Technology Ltd, China) was used as the flame retardant agent, and PER as the carbon source (i.e. the char forming agent).

The DPS synergist (which was cryo-crushed), PER and MCA were pre-mixed at a weight ratio of 1:0.8:3.2, after which the mixture was compounded with PA6 pellets. The overall loading of (DPS+PER+MCA) ranges from 6 wt % to 10 wt %, being 6 wt %, 8 wt %, and 10 wt %. The composite pellets were then injection moulded into coupons for mechanical and flame retardancy testing.

### Example 3A: Comparative Example 1

PA6 (Ultramid B3K, BASF) was used as the polymer matrix (i.e. the polyamide), and ADP (Sanwa Flame Retardant Technology Ltd, China) was used as the flame retardant agent. Without adding any other components, ADP was compounded with PA6 pellets directly. The loading of ADP ranges from 6 wt % to 15 wt %, being 6 wt %, 8 wt %, 10 wt %, 12.5 wt % and 15 wt %. The composite pellets were then injection moulded into control coupons for mechanical and flame retardancy testing and comparison.

### Example 3B: Comparative Example 2

PA6 (Ultramid B3K, BASF) was used as the polymer matrix (i.e. the polyamide), and MCA (Sanwa Flame Retardant Technology Ltd, China) was used as the flame retardant agent. Without adding any other components, MCA was compounded with PA6 pellets directly. The loading of ADP ranges from 6 wt % to 15 wt %, being 6 wt %, 8 wt %, 10 wt %, 12.5 wt % and 15 wt %. The composite pellets were then injection moulded into control coupons for mechanical and flame retardant testing and comparison.

### Example 3C: Control (denoted as “benchmark” in the drawings)

PA6 (Ultramid B3K, BASF) was used as the polymer matrix (i.e. polyamide), and Exolit® OP 1314 was used as the flame retardant agent. A powder mixtured was formed by mixing the two, and then compounded with PA6 pellets directly. The loading of Exolit® OP 1314 ranges from 6 wt % to 15 wt %, being 6 wt %, 8 wt %, 10 wt %, 12.5 wt % and 15 wt %. The composite pellets were then injection moulded into benchmark coupons for mechanical and flame retardancy testing, and comparison with aforesaid examples.

### Example 4: Characterization Methods and Discussion on Results

The flame retardant property, tensile properties and impact property of the composites were investigated based on UL 94, ASTM D638 and ASTM D256 standards, respectively. For the UL 94 test, a specimen thickness of 3.2 mm was chosen, and the time required for the flame to extinguish after removing the flame was recorded to differentiate the flame retardant performance of one another.

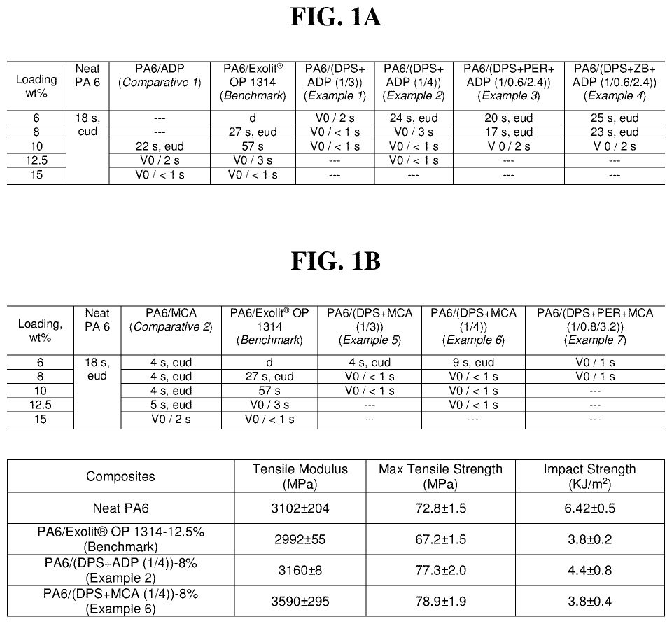

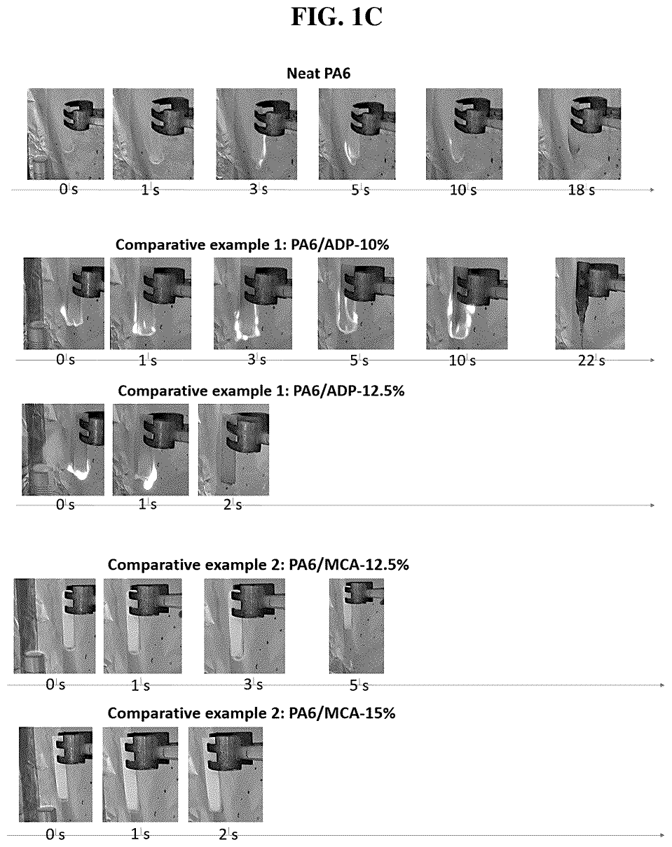

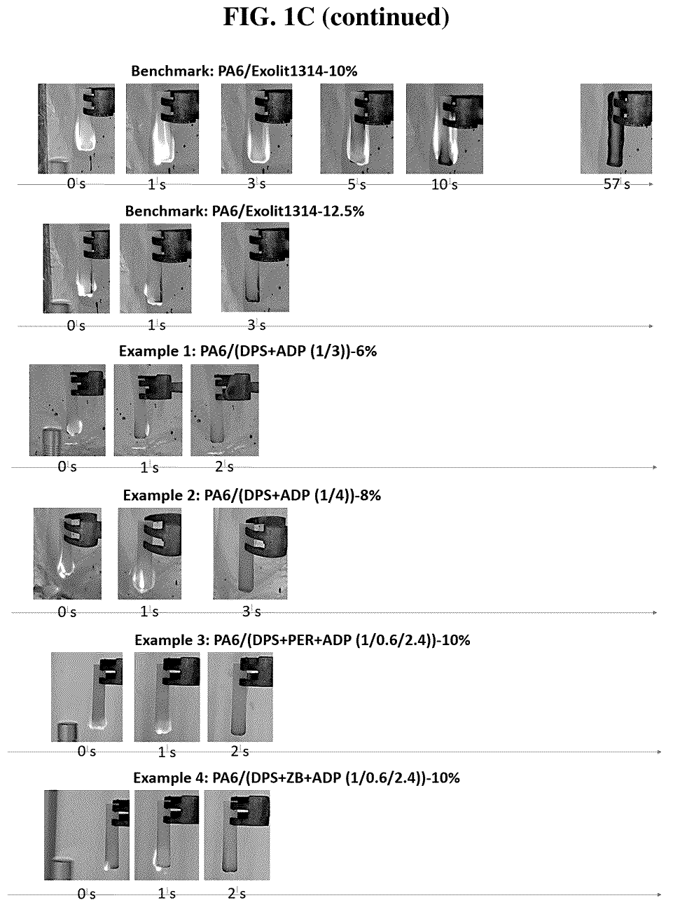

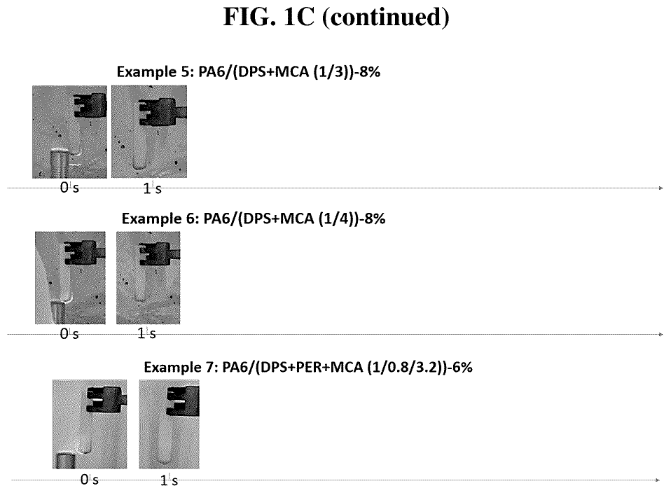

As presented in FIG. 1A, compared with pure (i.e. neat) PA 6 that shows flame extinguish upon dripping (eud) behaviour in about 18 s, the introduction of ADP into PA 6 with loading of 12.5 wt % shows UL94 VO rating is met, and the introduction of Exolit® OP 1314 in the control sample, with loading of 12.5 wt % also shows UL94 VO rate is met. The combination of DPS and ADP at weight ratios of 1 to 3 and 1 to 4 (examples 2A and 2B) significantly reduce the overall loading to 6 wt % and 8 wt %, respectively, in order to achieve the VO rating. The combinations of DPS, PER and ADP (example 2C) as well as DPS, ZB and ADP (example 2D) require overall loading of 10 wt % to achieve VO rate, which is still lower than the comparative and control samples.

As another comparative example, as presented in FIG. 1B, the introduction of MCA into PA6 requires loading of 15 wt % to achieve VO rate without dripping, while the lower loadings induce dripping to extinguish the burning. Comparing with that and the control, the combination of DPS and MCA at weight ratios of 1 to 3 and 1 to 4 (examples 2E and 2F) significantly reduce the overall loading to 8 wt % in both cases in order to achieve VO rate without dripping, and that of DPS, PER and MCA (example 2G) requires loading of 6 wt % for VO rate. All are much lower than the comparative and control samples.

FIG. 1C shows the fire extinguishing behaviour of all the samples, from which the flame retardancy performance can be clearly confirmed for the illustrative examples, suggesting the high flame retardancy efficacy of the developed formulations and composites.

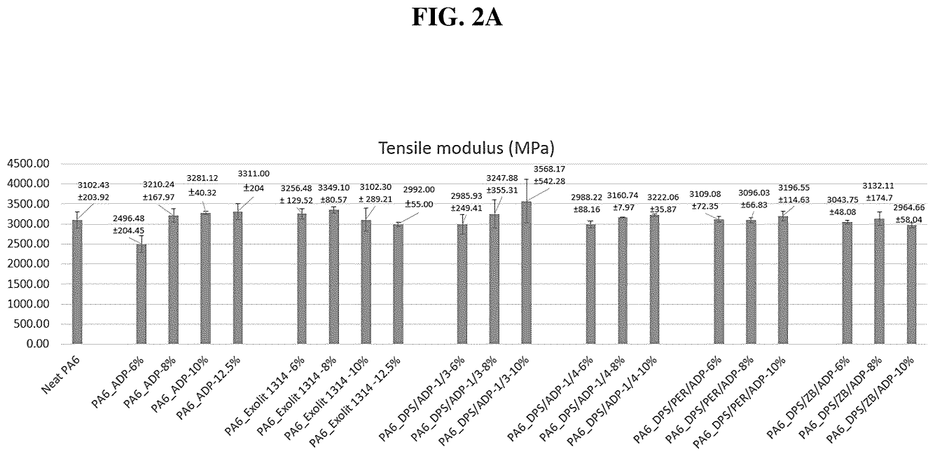

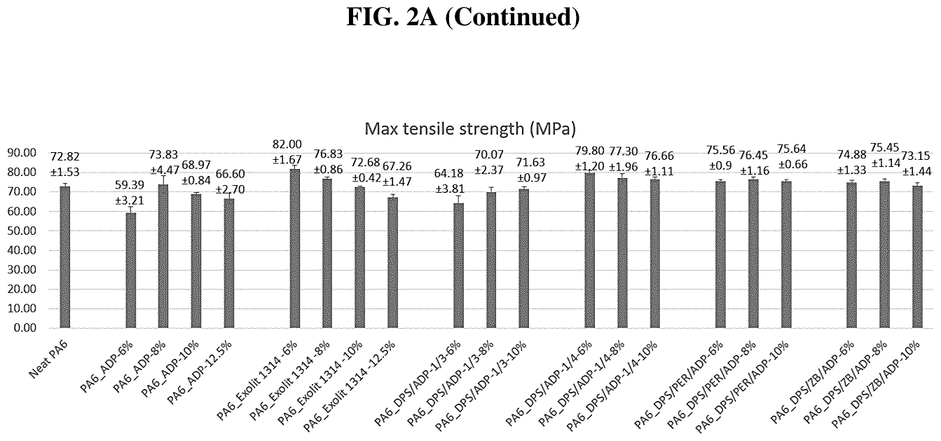

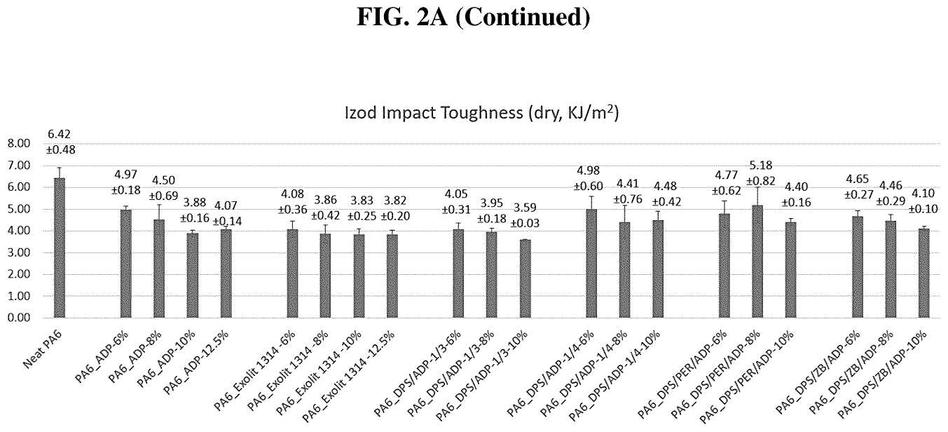

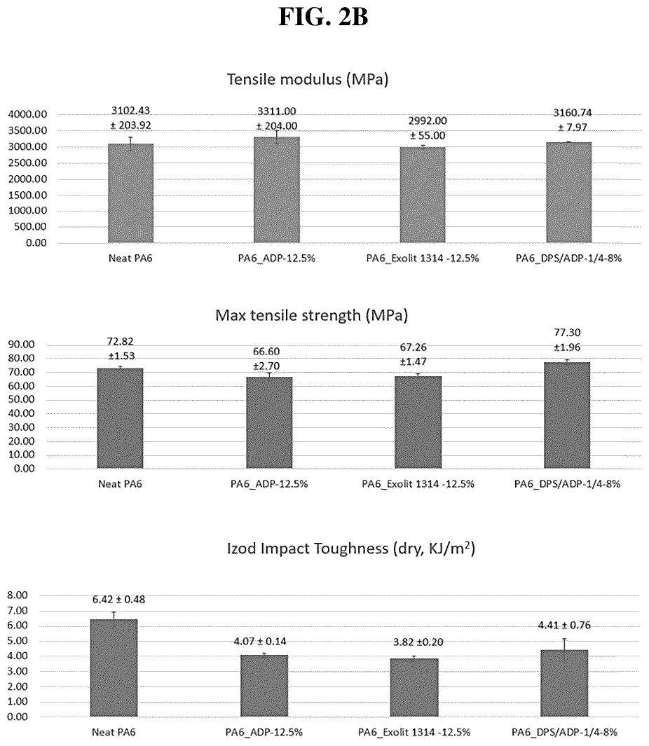

The mechanical properties of the composites in examples 2A to 2G were tested and compared with the comparative and control samples. Using ADP as the flame retardant, as shown in FIG. 2A and FIG. 2B, the overall mechanical properties of the illustrative composites (examples 2A to 2D) are comparable with the comparative composite (example 3A) and the control. In this case, however, it can be noted that a lower flame retardant filler loading favours the maximum tensile strength and impact strength. Taking the filler system of FR (e.g DPS)/ADP (at weight ratio of 1 to 4) as an elaboration, a loading of 8 wt % is needed to achieve VO rate (vs. 12.5 wt % using pure ADP and 12.5 wt % using Exolit® OP 1314), and under the premise of VO rating, the maximum tensile strength and impact strength of the developed composite is better than the comparative composite and the benchmark (FIG. 2B). This further confirms the values of lower flame retardant agent loading, i.e., lower cost and well-balanced flame retardancy and mechanical properties of the present composite.

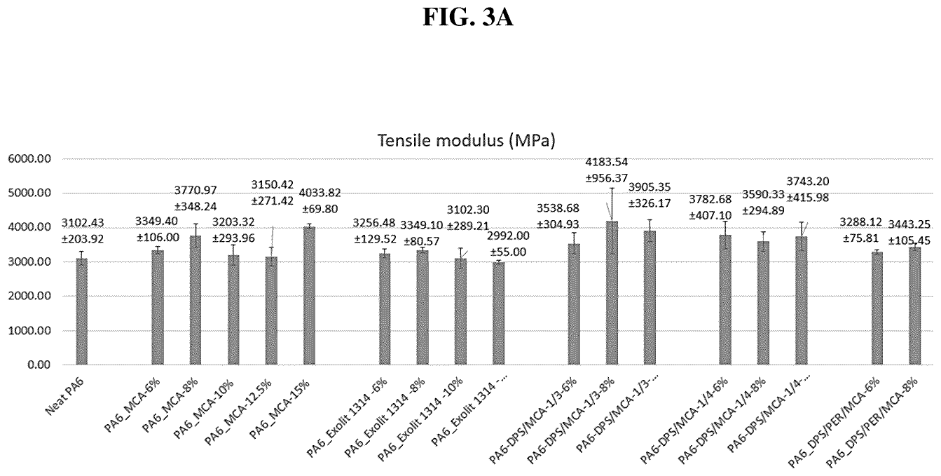

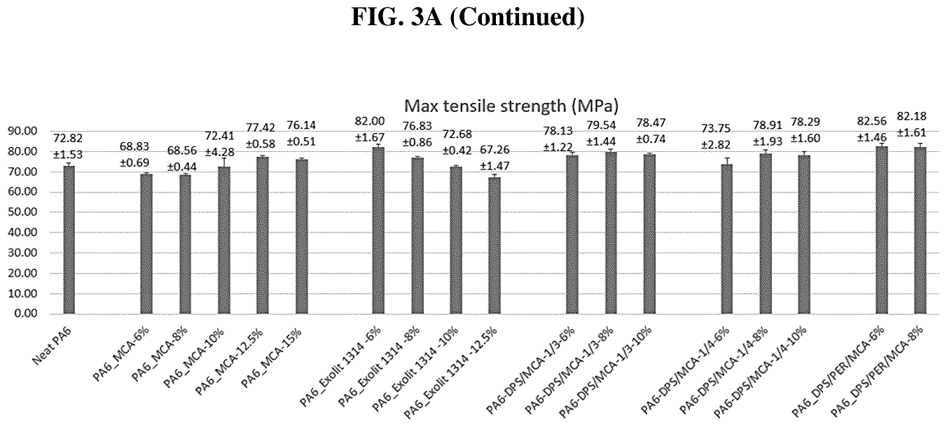

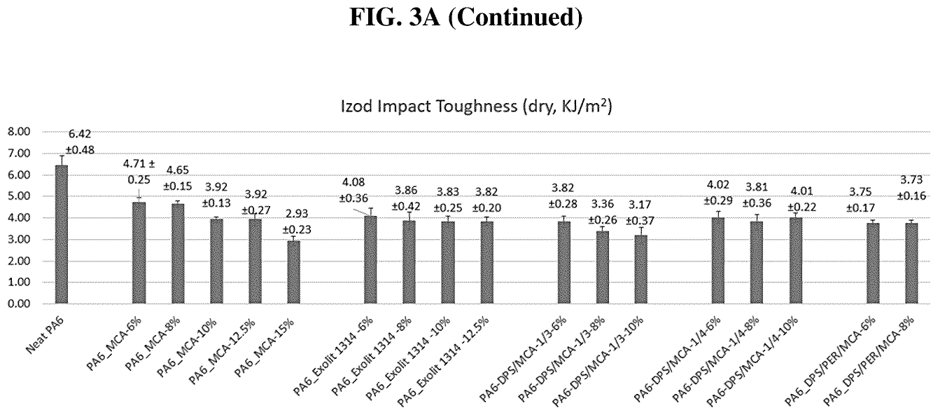

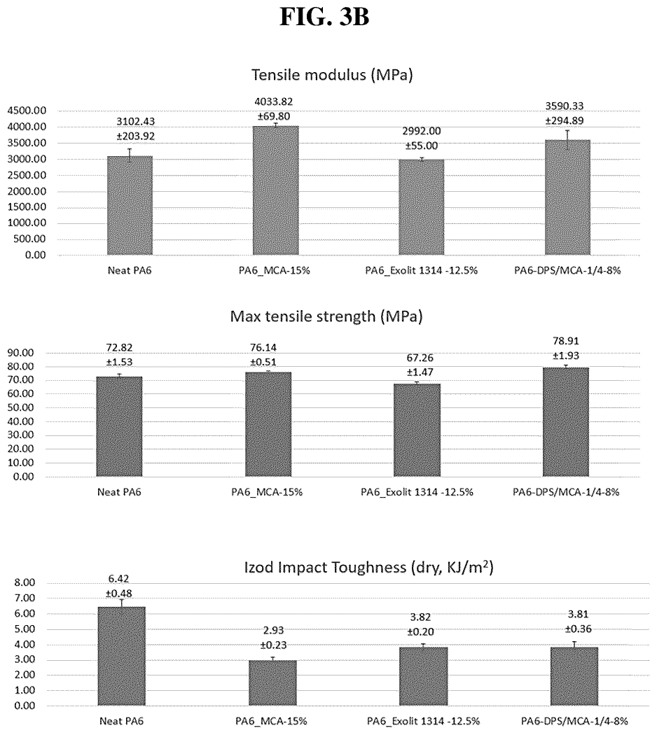

Using MCA as the flame retardant agent, the mechanical properties of the obtained illustrative composites (examples 2E to 2G) are shown in FIG. 3A and compared with comparative composites (example 3B) and the benchmark. Similarly, under the premise of VO rate in this case, a lower flame retardant (FR) filler loading (8 wt % using FR/MCA (at weight ratio of 1 to 4) versus 15 wt % using MCA and 12.5 wt % using Exolit® OP 1314) favors the maximum tensile strength and the impact strength (FIG. 3B). It is also noted that the developed FR/MCA filler systems possess higher tensile strength than the control.

While the present disclosure has been particularly shown and described with reference to specific embodiments, it should be understood by those skilled in the art that various changes in form and detail may be made therein without departing from the spirit and scope of the present disclosure as defined by the appended claims. The scope of the present disclosure is thus indicated by the appended claims and all changes which come within the meaning and range of equivalency of the claims are therefore intended to be embraced.

1. A flame retardant polyamide composite comprising:
a polyamide;
a synergist,
wherein the synergist comprises a polymer having a backbone and a side unit of 9,10-dihydro-9-oxa-10-phosphaphenanthrene 10-oxide bonded thereto, wherein the backbone of the polymer comprises at least one heterocyclic moiety; and
a flame retardant agent,
wherein the synergist and the flame retardant agent are present in an amount ranging from more than 0 to 10 wt %.

2. The flame retardant polyamide composite of claim 1, wherein the polyamide comprises a nylon, polyamide 6, polyamide 6,6, polyamide 4,6, polyamide 6,10, polyamide 11, or polyamide 12.

3. The flame retardant polyamide composite of claim 1, wherein the synergist comprises a polymer having a repeating unit represented by a chemical structure of:

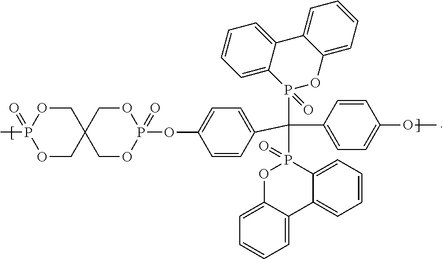

4. The flame retardant polyamide composite of claim 1, wherein the flame retardant agent comprises a phosphinate, a phosphate, a melamine, or a derivative thereof.

5. The flame retardant polyamide composite of claim 1, wherein the flame retardant agent comprises aluminum diethyl phosphinate, melamine phosphate, and/or melamine cyanurate.

6. The flame retardant polyamide composite of claim 1, wherein the synergist and the flame retardant agent are present in a weight ratio ranging from 1:2.4 to 1:4.

7. The flame retardant polyamide composite of claim 1, further comprising a char forming agent.

8. The flame retardant polyamide composite of claim 7, wherein the char forming agent comprises pentaerythritol or zinc borate.

9. The flame retardant polyamide composite of claim 1, further comprising a blowing agent.

10. The flame retardant polyamide composite of claim 9, wherein the blowing agent comprises melamine or a derivative thereof.

11. A method of forming the flame retardant polyamide composite of claim 1, the method comprising:
cryogenic milling a synergist;
mixing the synergist with a flame retardant agent to obtain a mixture; and
compounding the mixture with a polyamide to obtain the flame retardant polyamide composite.

12. The method of claim 11, wherein cryogenic milling the synergist is carried out at a temperature ranging from −250° C. to −100° C.

13. The method of claim 11, wherein cryogenic milling the synergist is carried out for at least 3 cycles, each cycle carried out at 10 to 15 Hz and for 1 to 3 minutes.

14. The method of claim 11, wherein mixing the synergist and the flame retardant agent comprises ball milling the synergist and the flame retardant.

15. The method of claim 11, wherein mixing the synergist and the flame retardant are carried out for 1 to 3 hours and at a speed of 200 to 300 rpm.

16. The method of claim 11, wherein mixing the synergist and the flame retardant further comprises mixing the synergist and the flame retardant in the presence of a char forming agent and/or a blowing agent to form the mixture.

17. The method of claim 11, wherein compounding the mixture with the polyamide is carried out in an extruder.

18. The method of claim 17, wherein the extruder is a twin screw extruder.

19. The method of claim 11, wherein compounding the mixture with the polyamide is carried out at a temperature of 220° C. to 260° C. and at a speed of 100 to 200 rpm.
